(19) United States
(12) Patent Application Publication
(10) Pub. No.: US 2022/0306256 A1
(43) Pub. Date: Sep. 29, 2022

(54) BOAT

(71) Applicant: HONDA MOTOR CO., LTD., Tokyo (JP)

(72) Inventor: Keiichi Ohiso, Wako-shi (JP)

(21) Appl. No.: 17/699,206

(22) Filed: Mar. 21, 2022

(30) Foreign Application Priority Data
Mar. 26, 2021 (JP) 2021-053279

(51) Int. Cl. B63H 19/02; B63B 39/00; B63B 79/10; B63B 79/40; B63H 21/21; B63H 21/17

(52) U.S. Cl. CPC B63H 19/02; B63B 39/00; B63B 79/10; B63B 79/40; B63H 21/21; B63H 21/17; B63B 35/34

(57) ABSTRACT

A boat includes: a hull; a float that supports the hull; a suspension that is disposed between the hull and the float and absorbs vibration transmitted from the float to the hull; a sensor that detects an interval between the hull and the float in a vertical direction; a control unit that generates a control signal in accordance with the interval; a battery that is charged or discharged in accordance with the control signal; and a motor that generates electric power by utilizing relative movement between the hull and the float in the vertical direction, charges the battery with the generated electric power in accordance with the control signal, and drives the suspension using the electric power discharged from the battery in accordance with the control signal.

### CROSS-REFERENCE TO RELATED APPLICATION

Priority is claimed on Japanese Patent Application No. 2021-053279, filed Mar. 26, 2021, the content of which is incorporated herein by reference.

### BACKGROUND OF THE INVENTION

### Field of the Invention

The present invention relates to a boat.

### Description of Related Art

A boat (a pontoon boat) including a hull and a float (a pontoon) is known. Here, since a float may vibrate greatly in a vertical direction in accordance with a wave height, a pontoon boat needs to absorb vibration transmitted from the float to a hull. For this reason, a pontoon boat may include a hydraulic suspension for absorbing vibration. A pontoon boat including a hydraulic suspension purposely generates energy for driving the hydraulic suspension by using an oil pump that consumes a large amount of fuel. Japanese Unexamined Patent Application, First Publication No. 2020-014363 discloses a regeneration device that generates regeneration electric power.

### SUMMARY OF THE INVENTION

A pontoon boat may include an electric suspension instead of a hydraulic suspension. A pontoon boat including an electric suspension uses electric power generated by consuming a large amount of fuel to drive the electric suspension. For this reason, in a case in which an amount of energy consumption (electric power consumption) is inhibited, there is a problem that a suspension for inhibiting vibration of a hull cannot be driven.

Aspects according to the present invention have been made in consideration of such circumstances, and an object thereof is to provide a boat in which a suspension for inhibiting vibration of a hull can be driven while an amount of energy consumption is inhibited.

In order to solve the above problems and achieve the above object, the present invention has adopted the following aspects.

(1) A boat according to one aspect of the present invention includes: a hull; a float that supports the hull; a suspension that is disposed between the hull and the float and absorbs vibration transmitted from the float to the hull; a sensor that detects an interval between the hull and the float in a vertical direction; a control unit that generates a control signal in accordance with the interval; a battery that is charged or discharged in accordance with the control signal; and a motor that generates electric power by utilizing a relative movement between the hull and the float in the vertical direction, charges the battery with the generated electric power in accordance with the control signal, and drives the suspension using the electric power discharged from the battery in accordance with the control signal.

(2) In the above aspect (1), in a case in which a state of charge of the battery is equal to or higher than a predetermined value, the control unit may execute predetermined processing for limiting electric power generation of the motor.

(3) In the above aspect (2), the control unit may charge another battery with the electric power generated by the motor or reduce efficiency of the electric power generation of the motor as the predetermined processing.

(4) In the above aspect (2), a propeller that propels the hull using the electric power discharged from the battery may be further provided, and the control unit may drive or idle the propeller using the motor as the predetermined processing.

(5) In the above aspects (1) to (4), in a case in which a rotation direction of the motor is switched, the control unit may correct a command value of a rotation speed of the motor in accordance with backlash of a gear that drives the suspension.

According to the aspects (1) to (5), since the electric power is generated by using the relative movement between the hull and float in the vertical direction, the battery is charged with the generated electric power in accordance with the control signal, and the suspension is driven by the electric power discharged from the battery in accordance with the control signal, the suspension inhibits the vibration of the hull while inhibiting the amount of energy consumption.

### BRIEF DESCRIPTION OF THE DRAWINGS

FIG. 1 is a top view of a boat according to a first embodiment of a structure.

FIG. 2 is a side view of the boat in FIG. 1.

FIG. 3 is a side view of a boat according to a second embodiment of a structure.

FIG. 4 is a top view of the boat in FIG. 3.

FIG. 5A is an enlarged view of the vicinity of a gear train in FIG. 3.

FIG. 5B is a diagram of the vicinity of the gear train in FIG. 5A from a front side.

FIG. 5C is a diagram of the vicinity of the gear train in FIG. 5A from above.

FIG. 6 is a diagram showing a configuration example of a control device.

FIG. 7 is a diagram showing an example of a control method.

FIG. 8 is a flowchart showing an example of operating each functional unit of the boat.

FIG. 9 is a diagram showing an example of distributing regeneration electric power in a case in which a state of charge is high.

FIG. 10 is a diagram showing examples of an engaging tooth surface during electrical driving and the engaging tooth surface during regeneration.

FIG. 11 is a flowchart showing an example of updating a command value of a rotation speed.

FIG. 12 is a diagram showing an example of a hardware configuration of the control device (a computer).

### DETAILED DESCRIPTION OF THE INVENTION

### First Embodiment of Structure

A boat of a first embodiment will be described below on the basis of the drawings. Unless otherwise specified, directions such as forward, rearward, leftward, and rightward in the following description are the same as directions in a boat 1 described below. Further, in appropriate locations in the drawings used in the following description, an arrow FR indicating a forward direction of the boat 1, an arrow LH indicating a leftward direction of the boat 1, and an arrow UP indicating an upward direction of the boat 1 are shown.

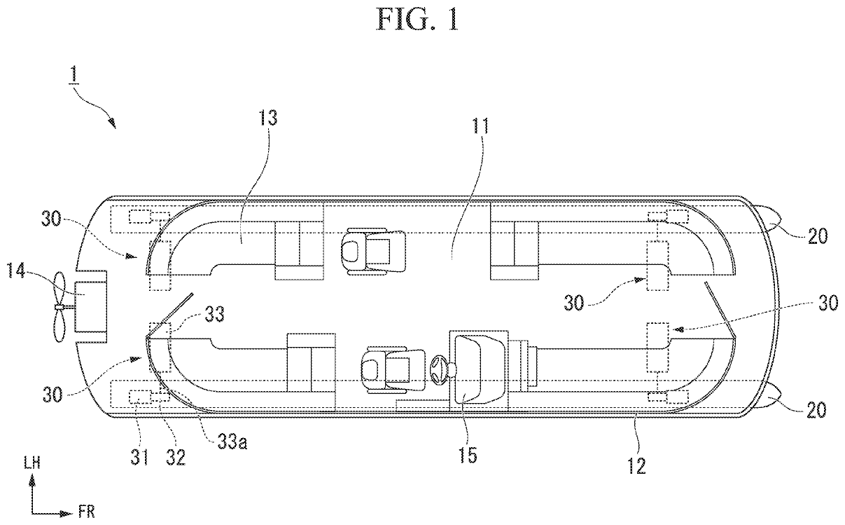

As shown in FIG. 1, the boat 1 includes a hull 10, floats 20, conversion mechanisms 30, and suspensions 40.

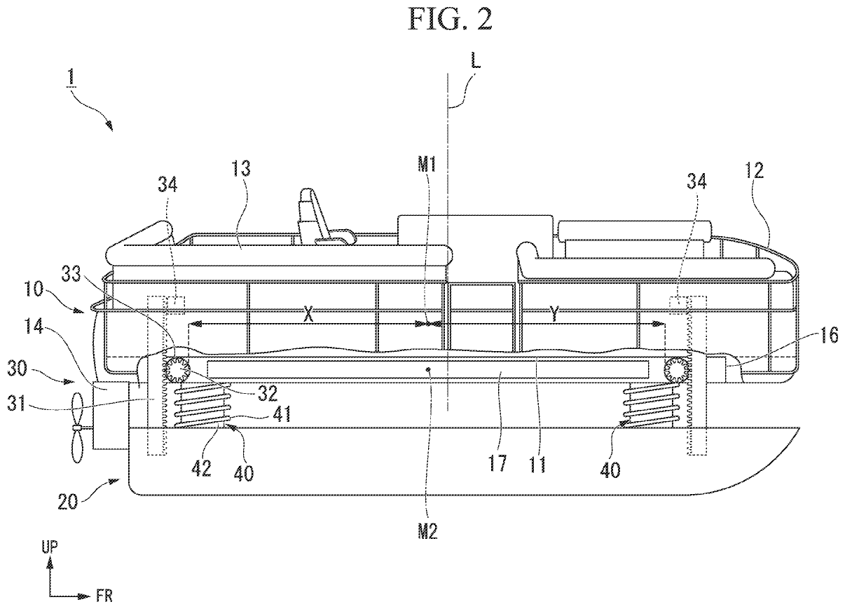

The hull 10 has a floor portion 11, a fence 12, seats 13, a propeller 14, an operation portion 15, and a storage chamber 16 (see FIG. 2). The floor portion 11 is a portion that supports loads of occupants and structures on the hull 10. The fence 12 is provided to surround the vicinity of an outer edge of the floor portion 11 and extends upward from the floor portion 11. The seats 13 are provided on the floor portion 11. In the example of FIG. 1, the seats 13 are disposed at four corners of the floor portion 11 having a substantially rectangular shape. A layout of the seats 13 and the like can be appropriately changed. The propeller 14 is provided at a rear end portion of the hull 10 and outputs a thrust for the hull 10 to navigate. The propeller 14 is provided with a screw and is configured such that turning on or off, an output or the like thereof is controlled by a command from the control unit 15.

As shown in FIG. 2, the storage chamber 16 is provided in a lower portion of the hull 10 (a portion below the floor portion 11). The storage chamber 16 has a waterproof structure so that water does not enter the inside of it. A battery 17 and the like are disposed in the storage chamber 16.

The floats 20 are provided below the hull 10. As shown in FIG. 1, in the present embodiment, the number of floats 20 included in the boat 1 is two. The two floats 20 extend in a longitudinal direction of the boat and are disposed with an interval therebetween in a lateral direction of the boat. Buoyancy acts on the floats 20. Due to this buoyancy, the floats 20 support the hull 10 via the conversion mechanisms 30 and the suspensions 40.

The conversion mechanisms 30 are configured to convert energy generated by a relative movement between the hull 10 and the floats 20 in the vertical direction to generate other forms of energy (for example, electrical energy). The conversion mechanisms 30 of the present embodiment each include a rack gear 31, a pinion gear 32, a motor 33, and a position sensor 34. The pinion gear 32 is fixed to a rotation shaft 33a of the motor 33. The motor 33 is fixed to the hull 10. More specifically, the motor 33 is housed in the storage chamber 16 together with the battery 17 and is electrically connected to the battery 17.

The rack gear 31 extends in the vertical direction and engages with the pinion gear 32. A lower end portion of the rack gear 31 is fixed to the float 20. In order to engage the pinion gear 32 fixed to the motor 33 with the rack gear 31 while ensuring waterproofness of the storage chamber 16, for example, a structure in which the rotation shaft 33a penetrates a wall of the storage chamber 16 may be adopted. In this case, the waterproofness of the storage chamber 16 can be ensured by sealing a periphery of a portion of the rotation shaft 33a that penetrates the wall of the storage chamber 16.

When the hull 10 and the float 20 move relative to each other in the vertical direction, the rack gear 31 and the pinion gear 32 also tries to move relative to each other in the vertical direction. In this case, the pinion gear 32 rotates while engaging with the rack gear 31. The pinion gear 32 rotates the rotation shaft 33a, and thus the motor 33 generates electric power. This electric energy is stored in the battery 17. The electric energy stored in the battery 17 may be used to rotate the motor 33. By rotating the motor 33, an interval between the hull 10 and the float 20 in the vertical direction can be adjusted. A posture of the hull 10 can also be controlled by separately controlling the motors 33 disposed at four locations on front, rear, left and right sides of the hull 10. Alternatively, the electric energy stored in the battery 17 may be used for other purposes (for example, a power source of electrical products provided in the hull 10, power of the propeller 14, etc.).

In the present embodiment, the motor 33 has a columnar shape extending in a direction orthogonal to the vertical direction. In FIG. 1, the motor 33 extends in the lateral direction. However, the motor 33 may extend in the longitudinal direction or may extend diagonally with respect to the longitudinal direction and the lateral direction. The rotation shaft 33a also extends in the direction orthogonal to the vertical direction. As shown in FIG. 2, a size of the motor 33 in the vertical direction is smaller than a size of the battery 17 in the vertical direction. For this reason, the motor 33 can be disposed in the storage chamber 16 without increasing a size of the storage chamber 16 storing the battery 17 in the vertical direction. A shape of the motor 33 can be appropriately changed and may be, for example, a square shape.

The position sensor 34 is attached to an upper end portion of the rack gear 31. The position sensor 34 is configured to detect a position of the pinion gear 32 in the vertical direction with respect to the rack gear 31. By detecting the position of the pinion gear 32 in the vertical direction, the interval between the hull 10 and the float 20 in the vertical direction can be indirectly measured. When the motor 33 is driven using the electric energy stored in the battery 17, results measured by the position sensor 34 may be used.

The suspension 40 has a damper 41 and a spring 42. In the example of FIG. 1, a rod-shaped damper 41 is disposed inside the spring 42. However, a structure of the suspension 40 can be appropriately changed and the damper 41 may be disposed outside the spring 42, for example.

A virtual line L shown in FIG. 2 indicates a position of a center of the hull 10 in the longitudinal direction. A point M1 indicates a center of gravity of the hull 10, and a point M2 indicates a center of gravity of the battery 17. The center of gravity M1 of the hull 10 is located behind the virtual line L. With this arrangement, the boat 1 can be trimmed by the stern. A boat being trimmed by the stern means that a draft at the stern is larger than a draft at the bow.

In the present embodiment, the conversion mechanisms 30 and the suspensions 40 are provided to sandwich the center of gravity M1 of the hull 10 in the longitudinal direction. As shown in FIG. 1, two conversion mechanisms 30 are provided for one float 20. Although omitted in FIG. 1, with respect to the suspensions 40, two suspensions 40 are provided for one float 20. That is, the boat 1 includes the conversion mechanisms 30 and the suspensions 40 at four locations. However, the number of conversion mechanisms 30 and suspensions 40 can be appropriately changed. For example, in a case in which the number of floats 20 is three, the conversion mechanisms 30 and the suspensions 40 may be provided at six locations in total at front and rear end portions of each float 20. Alternatively, some floats 20 may not be provided with the conversion mechanisms 30 and the suspensions 40.

As shown in FIG. 2, in the present specification, in the longitudinal direction, a distance from the center of gravity M1 of the hull 10 to the rear conversion mechanism 30 is represented by X, and a distance from the center of gravity M1 to the front conversion mechanism 30 is represented by Y. In the case of X=Y, loads applied to the front and rear conversion mechanisms 30 can be made equal when vibration is absorbed, a specification of the motor 33, gear ratios of the rack gear 31 and the pinion gear 32, a specification of the spring 42, and the like can be made equal on the front and rear sides, and thus the conversion mechanism 30 and components of peripheral structures can be shared on the front and rear sides, and production efficiency of the boat 1 can be improved. Accordingly, it is preferable to set X=Y.

Depending on a usage mode of the boat 1, the load on the rear conversion mechanism 30 may be larger than the load on the front conversion mechanism 30. For example, in a case in which a heavy structure such as a waterslide is disposed at the rear end portion of the hull 10, the position of the center of gravity moves rearward, and a rear portion of the hull 10 tends to sink significantly. In order to keep the hull 10 horizontal, control is performed such that the rear conversion mechanism 30 is driven to increase an interval between the hull 10 and the float 20 in the vertical direction.

In this case, a load generated in the rear conversion mechanism 30 changes depending on the above distance X. Specifically, as the distance from the center of gravity M1 of the hull 10 to the rear conversion mechanism 30 increases, a load required for the rear motor 33 to keep the hull 10 horizontal can be reduced. In consideration of the position of the center of gravity according to such a usage mode, X>Y may be set.

As described above, the boat 1 of the present embodiment includes the hull 10, the floats 20 that support the hull 10, the suspensions 40 that are disposed between the hull 10 and the floats 20 and absorb vibrations transmitted from the floats 20 to the hull 10, and the conversion mechanisms 30 that convert energy generated by the relative movement of the hull 10 and the floats 20 in the vertical direction, in which the conversion mechanisms 30 are disposed to sandwich the center of gravity M1 of the hull 10 in the longitudinal direction. According to this configuration, the suspensions 40 can absorb the vibrations transmitted from the floats 20 to the hull 10. The conversion mechanisms 30 are disposed to sandwich the center of gravity M1 of the hull 10 in the longitudinal direction, and thus as front and rear sides of the hull 10 move up and down with respect to the floats 20 when the boat 1 navigates, it is possible to generate electric power while absorbing the vibrations using the front and rear conversion mechanisms 30. Further, since presence of the suspensions 40 and the conversion mechanisms 30 raises the position of the hull 10 in the vertical direction, open sea running performance of the boat 1 can be improved, and turning performance and riding comfort at the time of turning can be improved.

When the distance X from the center of gravity M1 of the hull 10 to the conversion mechanism 30 located rearward is defined as X, and the distance from the center of gravity M1 of the hull 10 to the conversion mechanism 30 located forward is defined as Y, X>Y may be satisfied. In this case, the position of the center of gravity moves rearward in accordance with the usage mode of the boat 1, and thus when the rear portion of the boat 1 is about to sink significantly, the load generated on the rear conversion mechanism 30 can be reduced.

The conversion mechanisms 30 in the present embodiment each have the motor 33 that generates electrical energy with the relative movement between the hull 10 and the float 20 in the vertical direction, the motor 33 is electrically connected to the battery 17, and the position of the center of gravity of the battery 17 coincides with the position of the center of gravity of the hull 10 in the longitudinal direction. In this case, by causing the position of the center of gravity of the heavy battery 17 to coincide with the position of the center of gravity of the hull 10, presence of the battery 17 inhibits a moment from acting on the boat 1, and the posture of the boat 1 can be stabilized.

The conversion mechanism 30 has the rack gear 31 that is fixed to the float 20 and is movable up and down with respect to the hull 10, the pinion gear 32 that engages with the rack gear 31, and the motor 33 having the rotation shaft 33a fixed to the pinion gear 32, the hull 10 has the battery 17 electrically connected to the motor 33, and the rotation shaft 33a extends in the direction orthogonal to the vertical direction. In addition, as shown in FIG. 2, the size of the motor 33 is smaller than the size of the battery 17 in the vertical direction. According to this configuration, it is possible to prevent the hull 10 from becoming larger in size in the vertical direction due to the presence of the motor 33. The battery 17 and the motor 33 can be easily disposed in the common storage chamber 16. By disposing the motor 33 together with the battery 17 in the storage chamber 16, the waterproof structure of the hull 10 can be simplified, and wiring for connecting the battery 17 with the motor 33 can be shortened.

### Second Embodiment of Structure

Next, a second embodiment according to the present invention will be described, and a basic configuration is the same as that of the first embodiment. For this reason, the same constituent elements will be denoted by the same reference numerals, the descriptions thereof will be omitted, and only different points will be described.

In the present embodiment, a structure and an arrangement of the conversion mechanism 30 are different from those in the first embodiment.

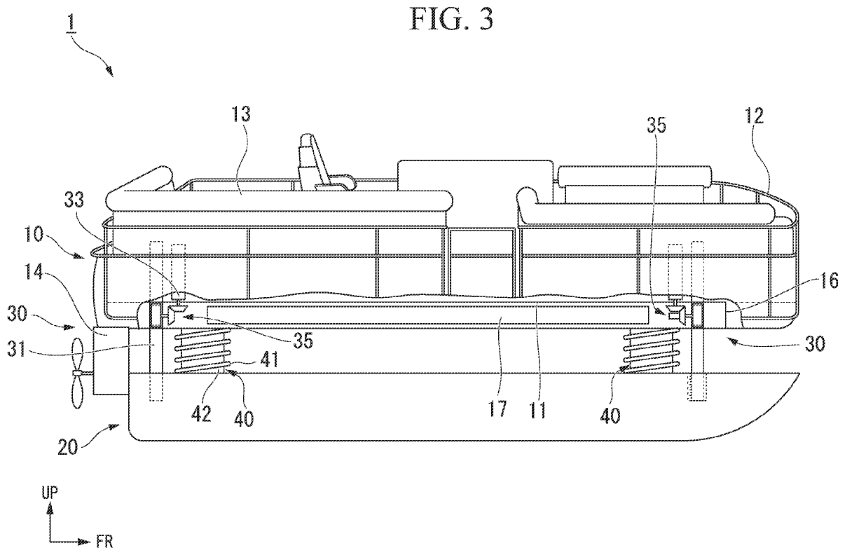

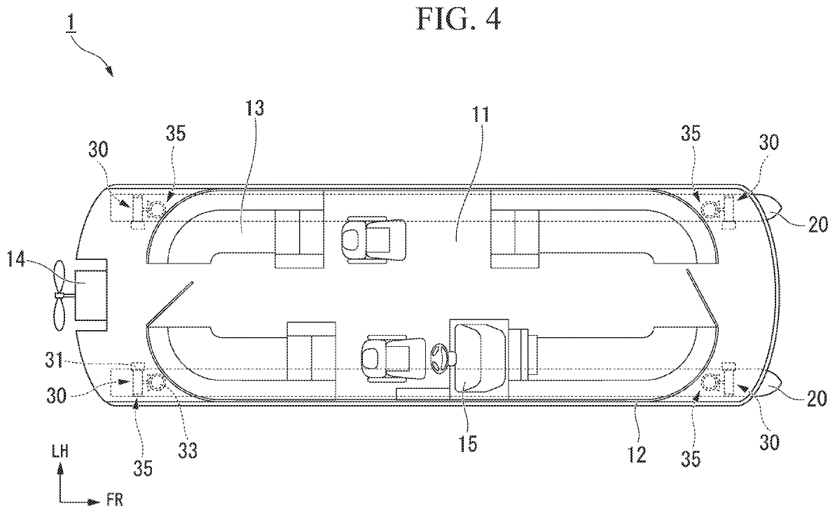

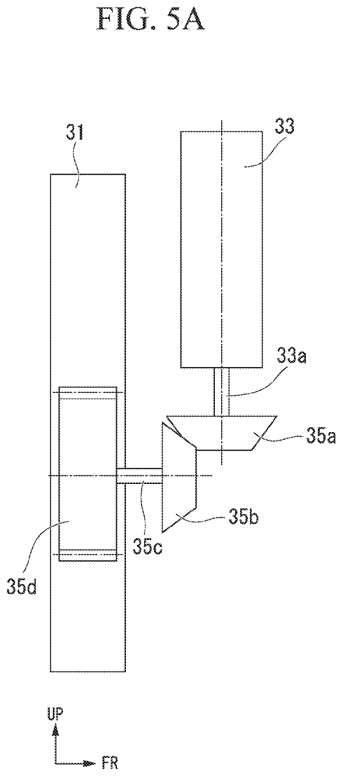

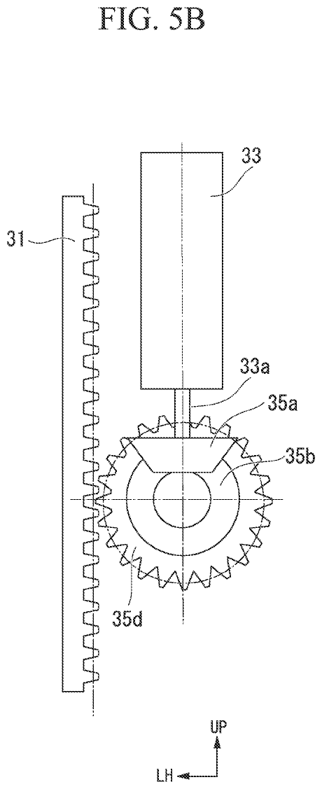

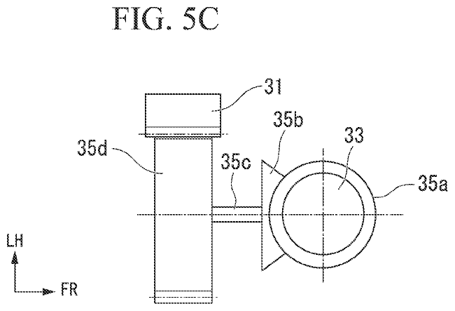

As shown in FIG. 3, the rotation shaft 33a of the motor 33 in the present embodiment extends in the vertical direction. As shown in FIG. 4, each conversion mechanism 30 has a gear train 35 that connects the motor 33 with the rack gear 31. As shown in FIGS. 5A to 5C, the gear train 35 includes a first bevel gear 35a, a second bevel gear 35b, a connecting shaft 35c, and a pinion gear 35d. The first bevel gear 35a is fixed to the rotation shaft 33a, and the first bevel gear 35a and the rotation shaft 33a rotate integrally. The second bevel gear 35b engages with the first bevel gear 35a. The connecting shaft 35c extends in a direction orthogonal to the vertical direction (longitudinal direction in FIG. 5A). The second bevel gear 35b and the pinion gear 35d are fixed to both end portions of the connecting shaft 35c. The second bevel gear 35b, the connecting shaft 35c, and the pinion gear 35d rotate integrally. The pinion gear 35d engages with the rack gear 31. The gear train 35 is configured to convert a rotational movement around a central axis of the rotation shaft 33a extending in the vertical direction into a vertical movement of the pinion gear 35d with respect to the rack gear 31.

As described above, the conversion mechanism 30 of the present embodiment has the rack gear 31 that is fixed to the float 20 and is movable up and down with respect to the hull 10, the motor 33 having the rotation shaft 33a, and the gear train 35 that connects the rotation shaft 33a with the rack gear 31, the hull 10 has the battery 17 electrically connected to the motor 33, and the rotation shaft 33a extends in the vertical direction. In this way, by adopting the arrangement in which the rotation shaft 33a of the motor 33 extends in the vertical direction, an area occupied by the conversion mechanism 30 when viewed in the vertical direction can be reduced. Thus, a space of the hull 10 can be used more effectively. For example, as shown in FIG. 4, in a case in which the conversion mechanism 30 is disposed on a back side of a corner portion of the seat 13 which is a round sofa, it is possible to avoid pressing of the conversion mechanism 30 on a space above the hull 10. Components of the conversion mechanism 30 such as the motor 33 may be disposed above the floor portion 11 and covered with a waterproof cover for preventing infiltration of water.

(Embodiment of Control)

[Overview]

The hull 10 of boat 1 (a wave power generation ship) includes a control device. The control device sets operation modes of the motors 33 disposed at four locations on the front, rear, left and right sides of the hull 10 for each motor 33 in accordance with the position of the pinion gear 32 (a detected value of the wave height). The operation mode is, for example, an electric mode and a regeneration mode. The electric mode is a mode in which the motor is driven by utilizing electric power. The regeneration mode is a mode in which the motor (a generator) generates electric power by utilizing the relative movement of the hull and the float.

In a case in which the operation mode is set to the electric mode, the motor 33 adjusts a stroke of the suspension 40 by driving the pinion gear 32 using electric power supplied from the battery 17. By adjusting the stroke of the suspension 40 in this way, the posture of the hull 10 is stabilized.

In a case in which the operation mode is set to the regeneration mode, the motor 33 functions as a generator. Here, the stroke of the suspension 40 changes in accordance with the wave height, and thus the pinion gear 32 is driven and the posture of the hull 10 is stabilized. The motor 33 generates regeneration power using the drive of the pinion gear 32. The motor 33 stores the regeneration power in the battery 17.

The control device (regeneration device) may limit the regeneration operation of the motor 33 in accordance with a state of charge (SOC) of the battery 17. Here, a power source of the propeller 14 of the boat 1 may be an engine alone, a hybrid (an engine and a battery), or a full electric motor (a battery only). The control device distributes the regeneration power to a predetermined functional unit in accordance with a form of the power source of the propeller 14.

When the mode is switched between the electric mode and the regeneration mode, the control device may add a correction value of a rotation speed (a torque) in consideration of the backlash of the pinion gear 32 to a command value of the rotation speed (torque) before updating. Thus, when the mode is switched between the electric mode and the regeneration mode, the rack gear 31 and the pinion gear 32 softly collide with each other on an engaging tooth surface, and thus it is possible to improve durability of the rack gear 31 and the pinion gear 32.

[Regeneration Control]

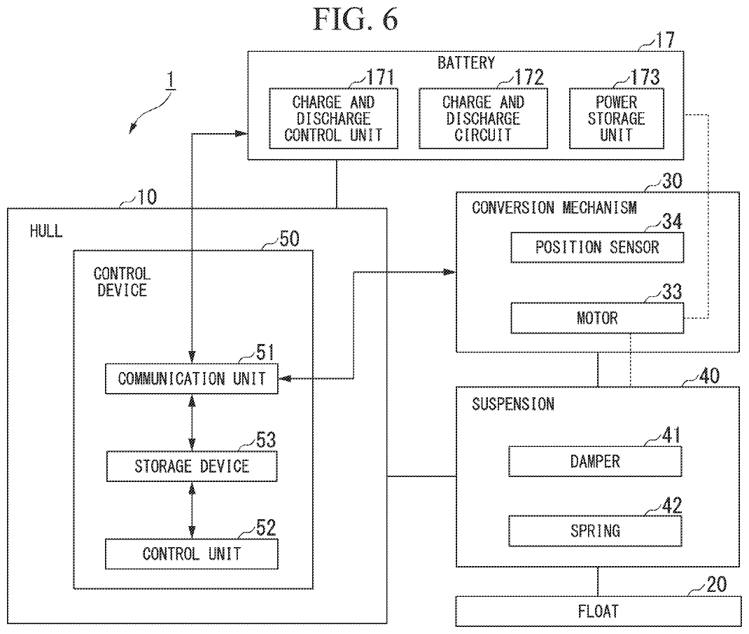

FIG. 6 is a diagram showing a configuration example of the control device 50 (regeneration device). The boat 1 includes the hull 10, the float 20, the battery 17, the conversion mechanism 30, and the suspension 40. The hull 10 includes the control device 50. The battery 17 includes a charge and discharge control unit 171, a charge and discharge circuit 172, and a power storage unit 173. The control device 50 includes a communication unit 51, a storage device 52, and a control unit 53.

The charge and discharge control unit 171 controls a state of charge of the power storage unit 173 by using the charge and discharge circuit 172 on the basis of a control signal transmitted from the control device 50. In a case in which the control signal indicates the regeneration mode, the power storage unit 173 stores electric power supplied from the motor 33 by using the charge and discharge circuit 172 (a converter circuit). In a case in which the control signal indicates the electric mode, the power storage unit 173 discharges the electric power to the motor 33 by using the charge and discharge circuit 172 (an inverter circuit).

The communication unit 51 acquires the control signal from the control unit 53. The communication unit 51 executes communication between the control device 50 and the battery 17. For example, the communication unit 51 transmits the control signal (an electric mode signal or a regeneration mode signal) generated by the control unit 53 to the charge and discharge control unit 171. For example, the communication unit 51 acquires state of charge data of the power storage unit 173 of the battery 17 from the charge and discharge control unit 171 at a predetermined period. The communication unit 51 outputs predetermined data acquired by communication to the control unit 53.

The communication unit 51 executes communication between the control device 50 and the conversion mechanism 30. For example, the communication unit 51 transmits the control signal (setting data) generated by the control unit 53 to the motor 33. For example, the communication unit 51 acquires position data (a detected value of the wave height) of the pinion gear 32 in the vertical direction with respect to the rack gear 31 from the position sensor 34 at a predetermined period.

The storage device 52 stores a program executed by the control unit 53 and data used in the program. The data used in the program is, for example, a threshold used for determination and a detected value (an actually measured value).

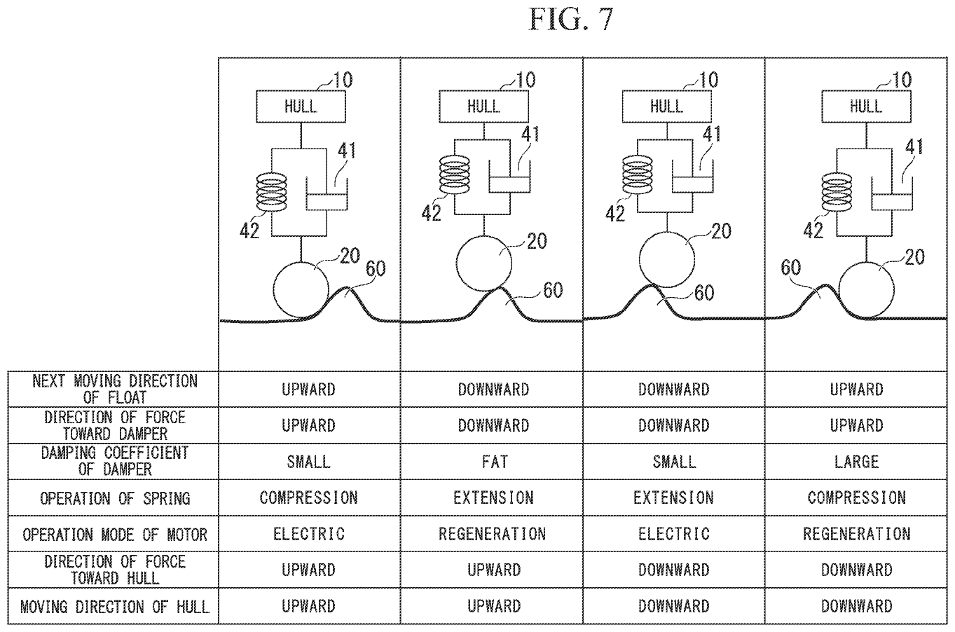

FIG. 7 is a diagram showing an example of a control method (a control cycle). An operation of the suspension 40 can be expressed by an operation of the damper 41 and an operation of the spring 42. The control unit 53 predicts whether or not the distance between the hull 10 and the float 20 changes on the basis of the position data (the detected value of the wave height) of the pinion gear 32. That is, the control unit 53 predicts a direction in which the hull 10 will move next and a direction in which the float 20 will move next, on the basis of time-series position data of the pinion gear 32.

A first state shown from the left in FIG. 7 is a state in which the suspension 40 is compressed because the wave 60 becomes higher. Here, as the wave 60 becomes higher, the next moving direction of the float 20 becomes upward. A direction of a force on the damper 41 is upward. A direction of a force on the hull 10 is upward. The next moving direction of the hull 10 is upward. In such a case, a change in the distance between the hull 10 and the float 20 becomes less than the threshold.

As described above, when the change in the distance between the hull 10 and the float 20 is less than the threshold, the control unit 53 generates the control signal indicating the electric mode. The control unit 53 reduces a damping coefficient of the damper 41. That is, the control unit 53 softens the damper 41. The motor 33 compresses the spring 42. Thus, the distance between the hull 10 and the float 20 in the vertical direction is maintained.

A second state shown from the left in FIG. 7 is a state in which the suspension 40 contracts most and the hull 10 begins to rise. Here, the next moving direction of the float 20 is downward. The direction of the force on the damper 41 is downward. The direction of the force on the hull 10 is upward. The next moving direction of the hull 10 is upward. In such a case, the change in the distance between the hull 10 and the float 20 in the vertical direction becomes equal to or larger than the threshold.

In this way, in a case in which the change in the distance between the hull 10 and the float 20 becomes equal to or larger than the threshold, the control unit 53 generates the control signal for the regeneration mode. The control unit 53 increases the damping coefficient of the damper 41. That is, the control unit 53 hardens the damper 41. The motor 33 uses energy to extend the spring 42 to generate electric power. Thus, the distance between the hull 10 and the float 20 in the vertical direction is maintained.

A third state shown from the left in FIG. 7 is a state in which the suspension 40 is extended because the wave 60 becomes lower. Here, as the wave 60 becomes lower, the next moving direction of the float 20 becomes downward. The direction of the force on the damper 41 is downward. The direction of the force on the hull 10 is downward. The next moving direction of the hull 10 is downward. In such a case, the change in the distance between the hull 10 and the float 20 becomes less than the threshold.

In this way, in a case in which the change in the distance between the hull 10 and the float 20 is less than the threshold, the control unit 53 generates the control signal for the electric mode. The control unit 53 reduces the damping coefficient of the damper 41. That is, the control unit 53 softens the damper 41. The motor 33 extends the spring 42. Thus, the distance between the hull 10 and the float 20 in the vertical direction is maintained.

A fourth state shown from the left in FIG. 7 is a state in which the suspension 40 is most extended and the hull 10 begins to descend. Here, the next moving direction of the float 20 is upward. The direction of the force on the damper 41 is upward. The direction of the force on the hull 10 is downward. The next moving direction of the hull 10 is downward. In such a case, the change in the distance between the hull 10 and the float 20 in the vertical direction becomes equal to or larger than the threshold.

In this way, in a case in which the change in the distance between the hull 10 and the float 20 becomes equal to or larger than the threshold, the control unit 53 generates the control signal for the regeneration mode. The control unit 53 increases the damping coefficient of the damper 41. That is, the control unit 53 hardens the damper 41. The motor 33 generates electric power by using energy that compresses the spring 42. Thus, the distance between the hull 10 and the float 20 in the vertical direction is maintained.

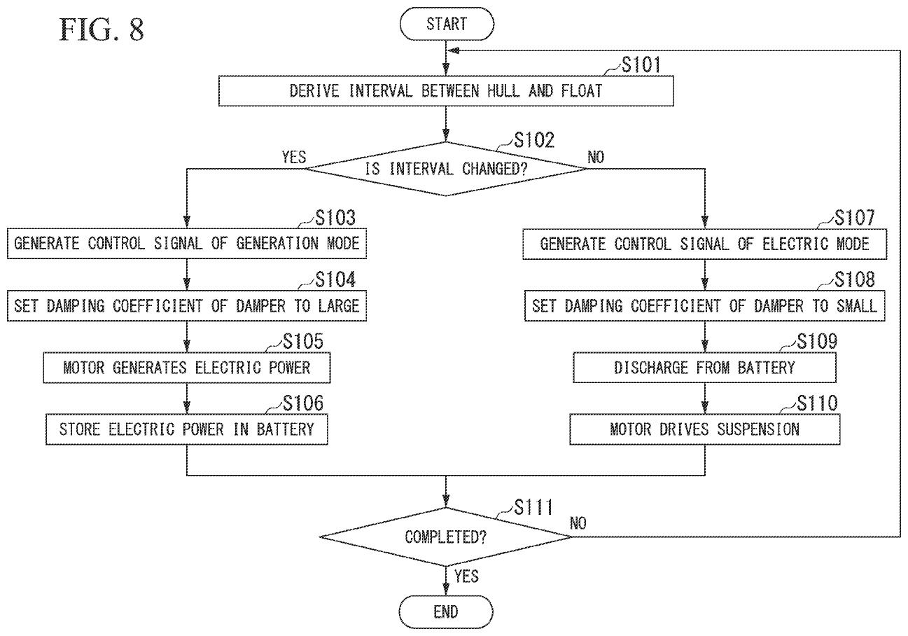

FIG. 8 is a flowchart showing an operation example of each functional unit of the boat 1. In the boat 1, each functional unit executes the operation shown in FIG. 8 at a predetermined period. The control unit 53 derives the distance between the hull 10 and the float 20 in the vertical direction on the basis of the time-series position data of the pinion gear 32. The position sensor 34 may detect the distance between the hull 10 and the float 20 in the vertical direction (step S101). The control unit 53 determines (predicts) whether or not the change in the distance between the hull 10 and the float 20 in the vertical direction is equal to or larger than the threshold (step S102).

In a case in which the change in the distance between the hull 10 and the float 20 is determined to be equal to or larger than the threshold, the control unit 53 generates the control signal for the regeneration mode (step S103). The control unit 53 hardens the damper 41 in the suspension 40. That is, the control unit 53 sets the damping coefficient of the damper 41 to “large” (step S104). The motor 33 generates electric power in accordance with the control signal (step S105). The motor 33 stores the electric power supplied from the motor 33 in the battery 17 (step S106).

In a case in which the change in the distance between the hull 10 and the float 20 is determined to be less than the threshold, the control unit 53 generates the control signal for the electric mode (step S107). The control unit 53 softens the damper 41 in the suspension 40. That is, the control unit 53 sets the damping coefficient of the damper 41 to “small” (step S108). The battery 17 is discharged in accordance with the control signal (step S109). The motor 33 uses the electric power supplied from the battery 17 to drive the suspension 40 (step S110).

The control unit 53 determines whether or not to end the operation shown in FIG. 8 on the basis of, for example, an instruction notified by an occupant (step S110). In a case in which the instruction to end the operation is not notified, the control unit 53 returns the process to step S101. In a case in which the instruction to end the operation is notified, the control unit 53 ends the operation shown in FIG. 8.

As mentioned above, the boat 1 includes the hull 10, the float 20, the suspension 40, the position sensor 34, the control unit 53, the battery 17, and the motor 33. The suspension 40 is disposed between the hull 10 and the float 20. The position sensor 34 detects the position of the pinion gear 32 in the vertical direction with respect to the rack gear 31. That is, the position sensor 34 detects the distance between the hull 10 and the float 20 in the vertical direction. The control unit 53 generates a control signal in accordance with the distance between the hull 10 and the float 20. For example, in a case in which it is predicted that the interval will be extended or shortened if nothing is controlled, the control unit 53 generates the control signal indicating the regeneration mode. The control unit 53 transmits the control signal to the motor 33 and the battery 17.

In a case in which the control signal indicates the regeneration mode, the motor 33 (generator) generates electric power by using the relative movement of the hull 10 and the float 20 in the vertical direction. The motor 33 stores the generated electric power in the battery 17. The battery 17 stores the electric power generated by the motor 33 in accordance with the control signal. In a case in which the control signal indicates the electric mode, the battery 17 discharges to the motor 33 in accordance with the control signal. The motor 33 drives the suspension 40 using the electric power discharged from the battery in accordance with the control signal.

In this way, the suspension 40 absorbs the vibration transmitted from the float 20 to the hull 10. Thus, it is possible to drive the suspension for inhibiting the vibration of the hull while inhibiting energy consumption.

Since the motor 33 executes not only drive processing but also regeneration processing, it is possible to improve riding comfort of the boat 1 while inhibiting the energy consumption. Depending on the height of the wave 60, it is possible to generate more electric power than an amount of electric power consumed for driving the suspension 40.

[Limitation in Accordance with State of Charge of Battery 17]

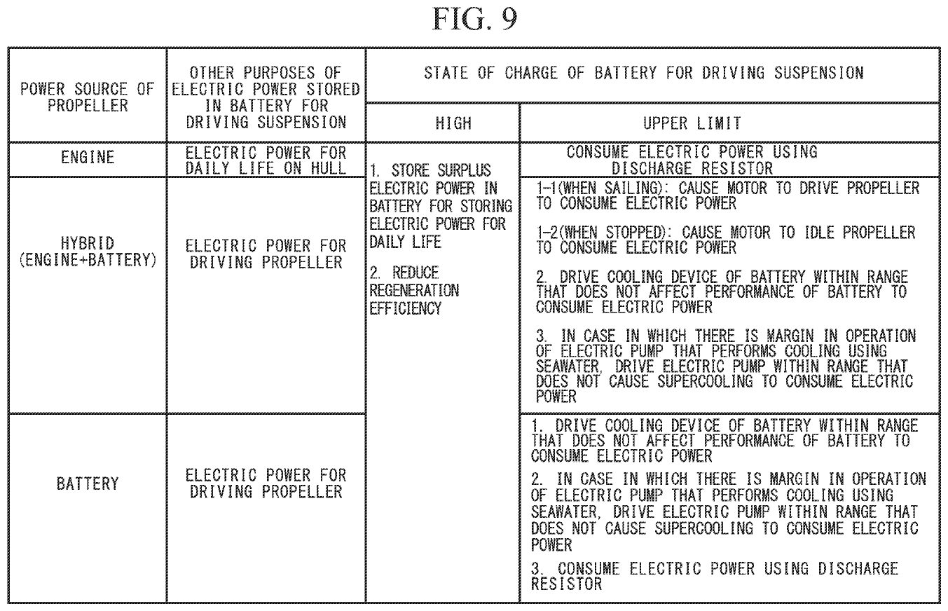

FIG. 9 is a diagram showing an example of distribution of regeneration power when the state of chare is high. The hull 10 may include the other battery for storing electric power for daily life. The other battery may be integrated with the battery 17.

In a case in which the state of charge of the battery 17 is high (in a case in which the state of charge is equal to or more than a predetermined value and less than an upper limit), the control unit 53 executes limitation processing to the regeneration as in each of operations (A1) and (A2) shown below.

(A1) The control unit 53 generates a control signal to store surplus electric power in a small battery for storing electric power for daily life.

(A2) The control unit 53 may generate a control signal so that regeneration efficiency in the motor 33 is reduced.

The control unit 53 may execute the limitation processing to the regeneration in accordance with a priority order determined for each of the above operations (A1) and (A2).

In a case in which the power source of the propeller 14 is only an engine, the electric power stored in the battery 17 for driving the suspension may be used for driving the suspension 40 and for daily life on the ship. In a case in which the state of charge of the battery 17 is the upper limit (above the predetermined value) (in a case in which it is difficult to cope with it only by the limitation processing to the regeneration), the control unit 53 consumes the electric power by using a discharge resistor.

In a case in which the power source of the propeller 14 is a hybrid (an engine and a battery), the electric power stored in the battery 17 for driving the suspension may be used for driving the suspension 40 and driving the propeller 14. In a case in which the state of charge of the battery 17 is the upper limit (greater than or equal to the predetermined value), the control unit 53 executes the limitation processing to the regeneration as in each of operations (B1) to (B3) shown below.

(B1-1) When the boat 1 is sailing, the control unit 53 causes the motor 33 to drive the propeller 14 using the electric power supplied from the battery 17 to consumes the electric power.

(B1-2) When the boat 1 is stopped, the control unit 53 causes the motor 33 to idle the propeller 14 (for example, the shaft connected to the engine) using the electric power supplied from the battery 17 to consume the electric power.

(B2) The control unit 53 operates a cooling device of the battery 17 within a range that does not affect the performance of the battery 17 to consume the electric power.

(B3) In a case in which there is a margin in an operation of an electric pump that performs cooling using seawater, the control unit 53 drives the electric pump within a range that does not cause supercooling to consume the electric power.

The control unit 53 may execute the limitation processing to the regeneration in accordance with the priority order determined for each of the above operations (B1) to (B3).

In a case in which the power source of the propeller 14 is fully electric (battery only), the electric power stored in the battery 17 for driving the suspension may be used for driving the propeller 14. In a case in which the state of charge of the battery 17 is the upper limit (greater than or equal to the predetermined value), the control unit 53 executes the limitation processing to the regeneration as in each of operations (C1) to (C3) shown below.

(C1) The control unit 53 operates the cooling device of the battery 17 within a range that does not affect the performance of the battery 17 to consume the electric power.

(C2) In a case in which there is a margin in the operation of the electric pump that performs cooling using seawater, the control unit 53 drives the electric pump within a range that does not cause supercooling to consume the electric power.

(C3) The control unit 53 consumes the electric power by using a discharge resistor.

The control unit 53 may execute the limitation processing to the regeneration in accordance with the priority order determined for each of the above operations (C1) to (C3).

As described above, in a case in which the state of charge of the battery 17 is equal to or greater than the predetermined value, the control unit 53 executes predetermined processing for limiting power generation of the motor. The control unit 53 stores the electric power generated by the motor 33 in another battery as the predetermined processing. The control unit 53 may reduce power generation efficiency of the motor 33 as the predetermined processing. The control unit 53 causes the motor 33 to drive or idle the propeller that propels the hull 10 using the electric power discharged from the battery 17 as the predetermined processing.

Thus, even in a case in which the state of charge of the battery 17 is equal to or greater than a predetermined threshold, it is possible to maintain the performance of the suspension 40.

[When Mode is Switched Between Electric Mode and Regeneration Mode]

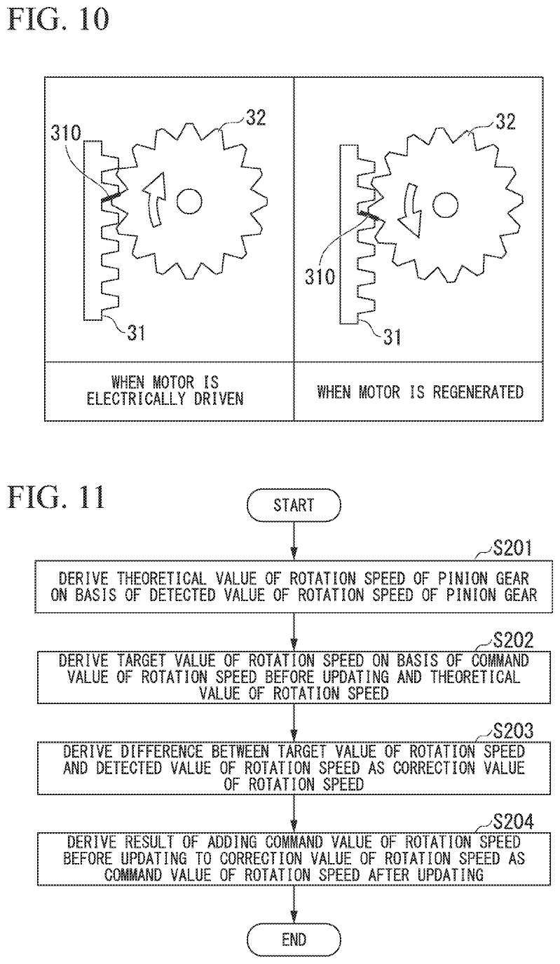

FIG. 10 is a diagram showing examples of the engaging tooth surface during electrical driving and the engaging tooth surface during regeneration. When the mode is switched between the electric mode and the regeneration mode, the rotation direction of the pinion gear 32 is switched. For this reason, a position of the engaging tooth surface 310 is changed to an opposite tooth surface of a backlash region of the pinion gear 32. Here, since the pinion gear 32 temporarily idles in the backlash region, a torque applied from the pinion gear 32 to the rack gear 31 temporarily becomes zero, and a rotation speed and an angular acceleration of the pinion gear 32 fluctuate.

Therefore, when the mode is switched between the electric mode and the regeneration mode, the control unit 53 may add a correction value of the rotation speed (torque) in consideration of the backlash of the pinion gear 32 to a command value of the rotation speed before updating. The rotation speed of the pinion gear 32 represents the position of the pinion gear 32 in the vertical direction with respect to the rack gear 31. The control unit 53 transmits a control signal representing the command value of the updated rotation speed to the motor 33 using the communication unit 51.

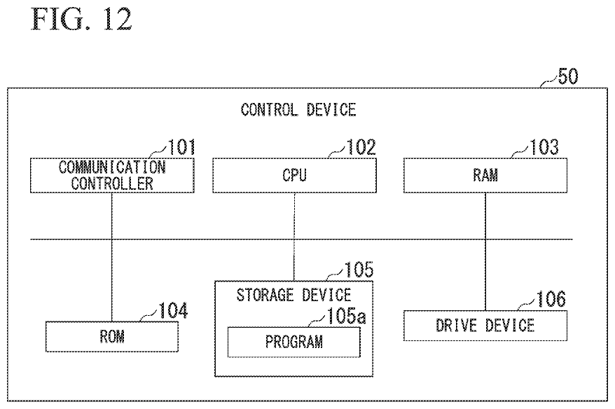

FIG. 11 is a flowchart showing an example of updating the command value of the rotation speed. The control unit 53 derives a theoretical value of the rotation speed of the pinion gear 32 on the basis of the detected value of the rotation speed or the angular acceleration of the pinion gear 32. The theoretical value of the rotation speed of the pinion gear is a rotation speed of the pinion gear when it is assumed that there is no backlash (step S201). The control unit 53 derives a target value of the rotation speed of the pinion gear 32 on the basis of the command value of the rotation speed before updating and the theoretical value of the rotation speed (step S202). The control unit 53 derives a difference between the target value of the rotation speed and the detected value of the rotation speed as the correction value of the rotation speed (step S203). The control unit 53 derives a result of adding the command value of the rotation speed before updating and the correction value of the rotation speed as the command value of the rotation speed after updating (step S204).

As described above, in a case in which the rotation direction of the motor 33 is switched, the control unit 53 corrects the command value of the rotation speed (torque) of the motor 33 in accordance with the backlash of the gear (for example, the rack gear and the pinion gear) that drives the suspension 40. Thus, when the mode is switched between the electric mode and the regeneration mode, the rack gear 31 and the pinion gear 32 softly collide with each other on the engaging tooth surface 310, and thus durability of the pinion gear 32 can be improved. It is possible to reduce a rattling noise between the rack gear 31 and the pinion gear 32.

[Hardware Configuration]

FIG. 12 is a diagram showing an example of a hardware configuration of the control device 50 (computer). As illustrated, the control device 50 has a configuration in which a communication controller 101, a CPU 102, a random access memory (RAM) 103 used as a working memory, a read only memory (ROM) 104 for storing a boot program and the like, a storage device 105 such as a flash memory and a hard disk drive (HDD), a drive device 106, and the like are connected to each other via an internal bus or a dedicated communication line. The communication controller 101 communicates with components other than the control device 50. The storage device 105 stores a program 105a executed by the CPU 102. This program is developed in the RAM 103 by a direct memory access (DMA) controller (not shown) or the like and is executed by the CPU 102. Thus, some or all of functional units of the control device 50 are realized.

The embodiment of the control described above can be expressed as follows.

The boat is configured to include the hull, the float that supports the hull, the suspension that is disposed between the hull and the float and absorbs vibration transmitted from the float to the hull, the sensor that detects the interval between the hull and the float in the vertical direction, the battery that is charged or discharged in accordance with the control signal, the motor that generates electric power by utilizing the relative movement of the hull and the float in the vertical direction, stores the generated electric power in the battery in accordance with the control signal, and drives the suspension using the electric power discharged from the battery in accordance with the control signal, the storage device that stores the program, and a hardware processor, in which the hardware processor executes the program stored in the storage device to generate the control signal in accordance with the interval.

Although aspects for implementing the present invention have been described above using the embodiments, the present invention is not limited to these embodiments, and various modifications and substitutions can be made without departing from the gist of the present invention.

That is, the technical scope of the present invention is not limited to the above-described embodiments, and various changes can be made without departing from the spirit of the present invention.

For example, in the above embodiments, the case in which electric power is generated by using the conversion mechanism 30 to charge the battery 17 has been described. However, the conversion mechanism 30 can be used for other purposes such as improving boarding and alighting performance by adjusting heights of a pier and the floor portion 11 when the boat 1 berths, or improving riding comfort of occupants by inclining the hull 10 inward when the boat 1 is turned.

For example, the above control device is not limited to being provided in a moving body such as a boat, but may be provided in a moving body such as a vehicle.

For example, in a case in which the position of the pinion gear 32 (detected value of the wave height) becomes equal to or higher than a predetermined threshold, the control unit 53 may execute processing of notifying an occupant of a warning indicating that the wave height is high. In the processing of notifying the occupant of the warning, for example, the control unit 53 turns on a light source.

For example, the control unit 53 may determine whether or not the hull 10 is receiving a transverse wave having a height equal to or higher than a predetermined height on the basis of positions of the pinion gears 32 disposed at four locations on the front, rear, left, and right sides of the hull 10. In a case in which the hull 10 receives a transverse wave having a height equal to or higher than a predetermined height and a transverse wave avoidance action of the boat 1 (steering of a rudder or thrust control of the propeller 14) is not executed, the control unit 53 may control the rudder and the thrust such that the bow is directed in a direction that does not receive the transverse wave.

For example, the control unit 53 may determine whether or not the hull 10 is receiving a trailing wave having a height equal to or higher than a predetermined height on the basis of the positions of the pinion gears 32 disposed at four locations on the front, rear, left, and right sides of the hull 10. In a case in which the hull 10 receives a trailing wave having a height equal to or higher than a predetermined height and the transverse wave avoidance action of the boat 1 (steering of a rudder or thrust control of the propeller 14) is not executed, the control unit 53 may control the rudder and the thrust such that the stern is directed in a direction of receiving the trailing wave.

In addition, it is possible to appropriately replace constituent elements in the above-described embodiments with well-known constituent elements without departing from the spirit of the present invention, and the above-described embodiments and modified examples may be appropriately combined.

The boat according to the above embodiments includes the hull (10), the floats (20) that support the hull (10), the suspensions (40) that are disposed between the hull (10) and the floats (20) and absorb vibrations transmitted from the floats (20) to the hull (10), and the conversion mechanisms (30) that convert the energy generated by the relative movement of the hull (10) and the floats (20) in the vertical direction, in which the conversion mechanisms (30) are disposed to sandwich the center of gravity (M1) of the hull (10) in the longitudinal direction.

According to the above aspect, the suspensions make it possible to absorb the vibrations transmitted from the floats to the hull. Since the conversion mechanisms are disposed to sandwich the center of gravity of the hull in the longitudinal direction, and thus as the front and rear sides of the hull move up and down with respect to the floats when the boat sails, it is possible to generate electric power while absorbing the vibrations using the front and rear conversion mechanisms.

Here, when the distance from the center of gravity (M1) of the hull (10) to the conversion mechanism (30) located rearward is defined as X, and the distance from the center of gravity (M1) of the hull (10) to the conversion mechanism (30) located forward is defined as Y, X>Y may be satisfied.

In this case, depending on the usage mode of the boat, when the rear portion of the boat is about to sink significantly, the load generated in the rear conversion mechanism can be reduced.

The conversion mechanism (30) may have the motor (33) that generates electrical energy as the hull (10) and the float (20) move relative to each other in the vertical direction, the motor (33) may be electrically connected to the battery (17), and the position of the center of gravity of the battery (17) may coincide with the position of the center of gravity of the hull (10) in the longitudinal direction.

In this case, by causing the position of the center of gravity of the heavy battery to coincide with the position of the center of gravity of the hull, it is possible to inhibit the moment from acting on the boat due to the presence of the battery and to stabilize the posture of the boat.

The conversion mechanism (30) may have the rack gear (31) that is fixed to the float (20) and is movable up and down with respect to the hull (10), the pinion gear (32) that engages with the rack gear (31), and the motor (33) having the rotation shaft (33a) to which the pinion gear (32) is fixed, the hull (10) may have the battery (17) electrically connected to the motor (33), the rotation shaft (33a) may extend in the direction orthogonal to the vertical direction, and the size of the motor (33) may be smaller than the size of the battery (17) in the vertical direction.

In this case, it is possible to prevent the hull from becoming larger in size in the vertical direction due to the presence of the motor. The battery and the motor can be easily disposed in the common storage chamber. By disposing the motor together with the battery in the storage chamber, the waterproof structure of the hull can be simplified and the wiring for connecting the battery to the motor can be shortened.

The conversion mechanism (30) may have the rack gear (31) that is fixed to the float (20) and is movable up and down with respect to the hull (10), the motor (33) having the rotation shaft (33a), and the gear train (35) that connects the rotation shaft (33a) to the rack gear (31), the hull (10) may have the battery (17) electrically connected to the motor (33), and the rotation shaft (33a) may extend in the vertical direction.

In this case, the area occupied by the conversion mechanism when viewed in the vertical direction can be reduced. Thus, the space of the hull can be used more effectively.

What is claimed is:

1. A boat comprising:
a hull;
a float that supports the hull;
a suspension that is disposed between the hull and the float and absorbs vibration transmitted from the float to the hull;
a sensor that detects an interval between the hull and the float in a vertical direction;
a control unit that generates a control signal in accordance with the interval;
a battery that is charged or discharged in accordance with the control signal; and
a motor that generates electric power by utilizing relative movement between the hull and the float in the vertical direction, charges the battery with the generated electric power in accordance with the control signal, and drives the suspension using the electric power discharged from the battery in accordance with the control signal.

2. The boat according to claim 1, wherein, in a case in which a state of charge of the battery is equal to or higher than a predetermined value, the control unit executes predetermined processing for limiting electric power generation of the motor.

3. The boat according to claim 2, wherein the control unit charges another battery with the electric power generated by the motor or reduces efficiency of the electric power generation of the motor as the predetermined processing.

4. The boat according to claim 2 further comprising a propeller that propels the hull using the electric power discharged from the battery,
wherein the control unit drives or idles the propeller using the motor as the predetermined processing.

5. The boat according to claim 1, wherein, in a case in which a rotation direction of the motor is switched, the control unit corrects a command value of a rotation speed of the motor in accordance with backlash of a gear that drives the suspension.
